(19) United States
(12) Patent Application Publication
(10) Pub. No.: US 2013/0057192 A1
(43) Pub. Date: Mar. 7, 2013

(54) AUTOMATIC REVERSIBLE SYNCHRONIZING SWITCHING CIRCUIT

(71) Applicants: JOEL AIRES PRATES, Ribeirao Preto (BR); Walter Aparecido Guimarães, Sertaozinho (BR); Sérgio Luis Litcanov, Sertaozinho (BZ); Miguel Carmona Ocaña, Mococa (BR)

(72) Inventors: JOEL AIRES PRATES, Ribeirao Preto (BR); Walter Aparecido Guimarães, Sertaozinho (BR); Sérgio Luis Litcanov, Sertaozinho (BZ); Miguel Carmona Ocaña, Mococa (BR)

(21) Appl. No.: 13/604,561

(22) Filed: Sep. 5, 2012

(30) Foreign Application Priority Data
Sep. 5, 2011 (BR) PI 1103937-0

(51) Int. Cl. H02P 1/52

(52) U.S. Cl. 318/709

(57) ABSTRACT

A multifunctional device for measuring fluorescence, luminescence and light transmission for diagnostics comprises a first and second group of screens mounted behind the rear surface of a sample solid carrier. A sample carrier is designed in the form of a biochip, cell, pan or microplate. The sample carrier's light sources are provided with light-absorbing elements for suppressing light reflected from the front surface of the sample carrier and from screen surfaces. Screen holders allow for alternatively mounting light reflective/retroreflective screens to maximize fluorescent or luminescent signal. A diffusing screen measures light transmission through the sample. Light-absorbing screens behind the rear surface of the sample and light-absorbing elements on light sources from the sample's top surface, increase signal-to-noise ratio. The device permits measuring signals on biochip surfaces and in solutions during hybridization or amplification reactions. The device and diagnostic method are suitable for mass screening of biological material samples.

### CROSS-REFERENCE TO RELATED APPLICATION

This application claims the benefit of the priority filing date in Brazilian patent no. PI 1103937-0 filed with the Brazilian Patent Office on Sep. 5, 2011. The earliest priority date claimed is Sep. 5, 2011.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present description relates to an automatic reversible synchronizing switching circuit in the field of electrical devices for engine driving and feeding. It was planned, designed and developed with the purpose of making its functions more versatile and optimized by working as an additional control circuit intended to be used for driving permanent magnet synchronous engines by means of a frequency inverter, and incorporated into the inverter or externally connected to the inverter (electronics/drive-dedicated).

Thus, said automatic reversible synchronizing switching circuit allows the engine driven by the inverter to start while being fed directly by the network, in synchronous rotation, and vice-versa. The engine is fed again by the inverter for use in other rotations, also allowing the transference to the network to be automatic or not, whatever the case may be.

The condition of operating directly in the network on synchronous rotation mode provides the engine maximum output, avoiding losses when the frequency inverter is used. Thus, the function of said circuit allows the engine to always be used, mainly when the engine works only at fixed rotation, equal or close to its synchronous rotation, but also in applications in which the engine works part of the time at fixed rotation, equal or close to its synchronous rotation, and other part of the time, at different rotations, adjusted by the inverter.

As is known mainly by those skilled in the art and concerning the state-of-the-art, a larger permanent magnet synchronous engine may only be put into movement and accelerated up to the desired rotation by a keyed device, in this case, the frequency inverter, or similar device.

The change from a close-to-synchronous routine to a synchronous one itself, as it occurs when an induction engine is replaced with a permanent magnet engine, fed by the network, may obviously affect the equipment.

When the fans are big, for example, the absorbed power may spread to an undesirable path, so it is up to the user to:

(a) keep the exact and desirable permanent magnet engine rotation by using the inverter;

(b) make any changes to the engine's replacement for it to rotate in synchronous rotation with the power absorbed previously, considering the power saving it provides.

However, if this desired rotation is fixed and close to the engine's synchronous rotation, as it is like in all replacements of induction engines with permanent magnet synchronous engines, the permanent magnet synchronous engine continues to be fed by its high output, because it operates in the inverter, and not in the network.

To minimize such inconveniences, there are converters that allow transference of feeding from the engine to the network, but only for maintenance purposes. This is done in such a way that, in replacements of induction engines with permanent magnets engines, feeding by the inverter is not automatically eliminated, resulting in these replacements not being effectively made. The permanent magnet engine continues operating by being fed by the inverter, even when close to its synchronous rotation, causing decreased efficiency of the permanent magnet engine.

### SUMMARY

The present description relates to an automatic reversible synchronizing switching circuit in the field of electrical devices for engine driving and feeding. Once automatic engine-network synchronization is selected for a permanent magnet synchronous polyphase engine driven by a frequency inverter with “start” control, the present automatic reversible synchronizing switching circuit would supervise the starting period by means of a setting button for a pre-established frequency ramp versus time. When reaching the engine's synchronous rotation, the circuit transfers its feeding directly to the network. At the first moment, the circuit separates the engine from the inverter, and thereafter, switches the engine to the network. Finally, if the option “automatic inverter stop” is selected, the circuit turns the variator itself off.

If “automatic engine-network synchronization” is not selected, said circuit may perform this transference at any moment, at the operator's or at the general control system's request, by using the control: “synchronize and switch: engine to network”.

Said automatic reversible synchronizing switching circuit may also perform the inverse function, i.e., transferring the engine feeding from the network to the inverter, anytime the operator or the general system sets this function by using the control: “synchronize and switch: inverter to engine”.

In this case, the circuit automatically turns the inverter on, switching the inverter to the network frequency and transferring feeding from the (moving) engine to the converter. First, the circuit disconnects the inverter from the network and immediately thereafter, connects the network to the inverter.

If the process requires deceleration, the circuit provides engine deceleration with a setting button for another pre-established frequency ramp versus time, up to synchronous rotation.

To perform these transferences at the most appropriate moment, an automatic reversible synchronizing switching circuit is provided with a synchronization module. The module checks the network and converter voltages for value, angle and phase, frequency and phase sequence, in order to reduce abnormal currents that may damage any part of the system.

Said circuit may also supervise the engine by means of a thermal protection and/or circuit breaker, or also by means of signals received from sensors (vibration, rotation and temperature), and installed in the engine.

### DRAWINGS

FIG. 1 is a block diagram of what the present automatic reversible synchronizing switching circuit is composed of.

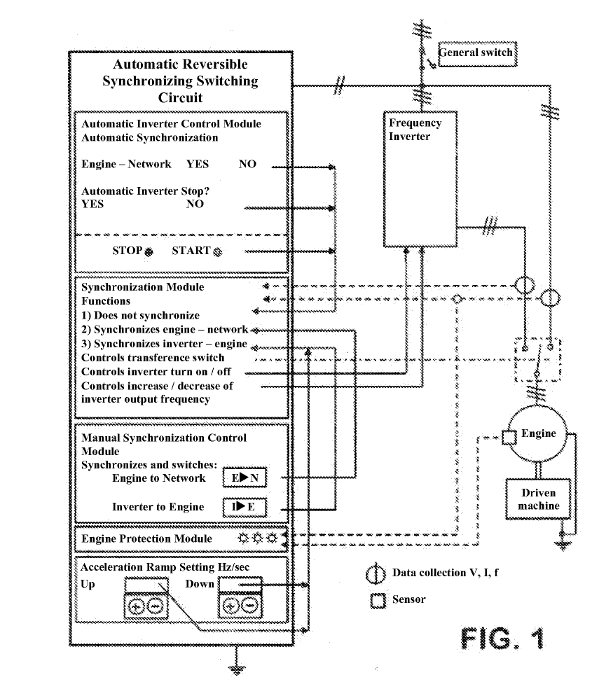

### DETAILED DESCRIPTION OF DRAWING

According to said diagram and consonant to the description herein provided, the present application for a patent of invention relates to an automatic reversible synchronizing switching circuit, in the field of electrical devices for engines driving and feeding, comprising:
one inverter control module, comprising:
automatic synchronization-engine-network-yes/no;
automatic inverter stop-yes/no;
stop/start;
one synchronization module, comprising the following functions:
does not synchronize;
synchronizes engine-network;
synchronizes inverter-engine;
controls transference switch;
controls inverter turn on/off;
controls increase/decrease of inverter output frequency;
one engine protection module interacting with the other components (general switch, frequency inverter, engine, driven machine, data collection V, I, f, sensor);
setting buttons for acceleration or deceleration ramps (Hz/sec-up/down).

Once the automatic engine-network synchronization is selected for a permanent magnet synchronous polyphase engine driven by a frequency inverter with “start” control, the present automatic reversible synchronizing switching circuit would supervise the starting period by means of a setting button for a pre-established frequency ramp versus time. When reaching the engine's synchronous rotation, the circuit transfers its feeding directly to the network. At the first moment, the circuit separates the engine from the inverter, and thereafter, switches the engine to the network. Finally, if the option “automatic inverter stop” is selected, the circuit turns the variator itself off.

If “automatic engine-network synchronization” is not selected, said circuit may perform this transference at any moment, at the operator's or at the general control system's request, by using the control: “synchronize and switch: engine to network”.

Said automatic reversible synchronizing switching circuit may also perform the inverse function, i.e., transferring the engine feeding from the network to the inverter, anytime the operator or the general system sets this function by using the control: “synchronize and switch: inverter to engine”.

In this case, the circuit automatically turns the inverter on, switching the inverter to the network frequency and transferring feeding from the (moving) engine to the converter. First, the circuit disconnects the inverter from the network and immediately thereafter, connects the network to the inverter.

If the process also requires deceleration, the circuit provides engine deceleration with a setting button for another pre-established frequency ramp versus time, up to synchronous rotation.

To perform these transferences at the most appropriate moment, an automatic reversible synchronizing switching circuit is provided with a synchronization module. The module checks the network and converter voltages for value, angle and phase, frequency and phase sequence, in order to reduce abnormal currents that may damage any part of the system.

It is important to emphasize that the automatic reversible synchronizing switching circuit does not require an encoder.

Said circuit may also supervise the engine by means of a thermal protection and/or circuit breaker, or also by means of signals received from sensors (vibration, rotation and temperature), and installed in the engine.

Related thereto, and also concerning conventional devices, the present automatic reversible synchronizing switching circuit is different and outstanding because the circuit adds the following advantages and benefits:
2% (larger engines) to 4% (medium engines) improvement in output;
concerning industrial applications, this decrease in consumption transforms into extremely high economical values, worldwide;
ideal for applications in which drastic reduction of power consumption is required, due to respective regulatory standards (ISO and the like);
engine insulation is not subject to constant demands from high voltages caused by inverter switching, leading to insulation wear and tear;
increased engine life and, consequently, increased maintenance requirements;
likewise, bearings do not suffer current-damaging passages against the ground, also coming from switching and passing through their rolling elements;
relevant decrease in bearings weariness, even with high voltage requests existing during start-up, however, in relatively short periods when compared to operation time, and in such a way that the risk of failures by weariness is considerably reduced;
frequency inverters used by the automatic reversible synchronizing switching circuit only for start-up and late definitive feeding transference from engine to engine may be of lesser quality and be offered at lower costs, with no lowering of the permanent magnet synchronous engine output;
increased life of frequency inverters;

Thus, every solution and advantage identified above directly influence lower industrialization costs and is reflected in the final commercialization price, among other overruling aspects, thereby benefiting the whole corresponding manufacturing sector.

It is important to emphasize that the frequency inverter, along with said automatic reversible synchronizing switching circuit may be incorporated into the engine itself, in the same way as converters. In addition, said circuit is also very useful in water pumping systems with multiple pumps (such as public sanitation services), in which the system may decide which pump takes on its regulating function, at adjustable speeds, while other pumps work at synchronous speeds. Full output permanent magnet synchronous engines also offer the possibility of permanent magnet engines working together in other required applications.

Despite the detailing of the present invention, it is important to emphasize that it does not limit its application to the aspects and features herein exemplified, once other modalities may be practiced or performed in a variety of ways, and it shall be understood that the terminology herein used was provided with the purpose of descriptions and not limitation.

What is claimed is:

1. A device for measuring fluorescence, luminescence, scattering and transmission of light for diagnostic comprising at least two light illuminators that form illumination of a working field, an optical system, a detector, an attachment point for a specimen, a solid carrier of a specimen for analysis, wherein a first group of screens and a second group of screens are present, the first group having at least two screens and the second group having at least two screens, where the screens are placed behind a rear surface of the specimen solid carrier, and said at least two light illuminators contain absorbents for suppressing reflected illumination from a front surface of the specimen solid carrier and surfaces of the screens, where the screens of the first group are positioned perpendicularly to an optical axis of a recording system and the screens of the second group are positioned perpendicularly to optical axes of said at least two light illuminators.

2. The device of claim 1, wherein a first screen from the first group is made so that it can reflect or retroreflect light fluxes of first and second illuminators and is positioned at a minimal distance (from 0.01 mm through 10.00 mm) from a rear surface of an object solid carrier, where a front surface of the first screen has a reflective or retroreflective layer.

3. The device of claim 2, wherein an attachment point of a holder for the object solid carrier provides a possibility to position the first screen of the first group behind a rear surface of the object solid carrier and to remove the object solid carrier from a field of view.

4. The device of claim 1, wherein a second screen of the first group of screens is positioned relative to a rear surface of the object solid carrier at a distance exceeding a distance from a point of intersection of lower flux boundaries and side boundaries of an optical cone of the recording system, where a front surface of the second screen of the first group of screens has a light-absorbing layer.

5. The device of claim 1, wherein a third screen of the first group of screens is placed behind a second screen of the first group, where a front surface of the third screen is made as a light-scattering surface.

6. The device of claim 1, wherein there is an additional attachment point for second and third screens of the first group of screens and it is possible to remove the second screen from an area of an optical cone of the recording system.

7. The device of claim 1, wherein there is at least one additional third light source, where the at least one additional third light source illuminates a front surface of a third screen, butt-end surfaces of the third screen, or a rear surface of the third screen.

8. The device of claim 1, wherein there are additional attachment points for a first and second screen of the second group of screens which make it possible to move in and remove the screens from the trajectory of the optical axes of the illuminators, where an attachment point of first and second screens of the second group is made using a hinge joint between the attachment point and the screen, and it is possible to turn the screens relative to the optical axes of the illuminators.

9. The device of claim 1, wherein the first screens of the second group has a light-reflective layer, and the second screens of the second group has a retroreflective surface.

10. The device of claim 1, wherein there is an additional third screens of the second group which is positioned behind first and second screens of the second group, a front surface of the third screens having an absorbing layer.

11. The device of claim 1, wherein the screens are a planar, angular, cylindrical or parabolic element with a reflective, light-absorbing or retroreflective surface.

12. The device of claim 1, wherein a light from the light sources is incident upon a working surface of an object for analysis at an angle α to an optical axis of the recording system in the range from 40 to 60 degrees.

13. The device of claim 12, wherein the light sources have an additional light-absorbing coating layered onto a surface of holders with cylindrical apertures, within which light diodes and light-absorbing elements are fixed, that are positioned on the surface of the illuminator casing, where light-absorbing elements have a planar, concave, cylindrical or parabolic shape and where the light sources emits illumination in the range from 300 through 800 nm.

14. The device of claim 1, wherein the specimen solid carrier for analysis is made as a biochip, a cell, or a microplate, said specimen solid carrier for analysis being a biological sample immobilized on a solid planar substrate, a biological sample placed within a flow-through cell, a biological sample placed within a hybridization solution, a biological sample layered on a flexible substrate pasted to a solid planar substrate, a sample immobilized on a gel substrate, or a biological sample fixed on a chromatographic carrier said biological sample chosen from a group consisting of DNA, proteins, enzymes, antibodies, antigens, and cells.

15. The method for performing diagnostic tests by illuminating a specimen immobilized on a solid carrier or placed in a reaction solution, wherein:
a) The mode of diagnostics is chosen from a group including measurements of light fluorescence, luminescence, scattering or transmission;
b) One or several screens are in turn introduced into the trajectory of optical axes of illuminators and/or in the trajectory of the optical axis of the recording system;
c) The object for analysis is placed in the object holder and it is introduced into the trajectory of optical axes of illuminators and the recording system;
d) Based on the preliminary image on the display, shooting conditions are chosen and the first image is saved;
e) The object is removed from the trajectories of the optical axes of the illuminators and the recording system;
f) The second image is saved;
g) A differential image of the first and second images is formed;
h) The differential image is multiplied pixel-by-pixel by the normalized coefficients and the processing of the obtained image is started.

16. The method of claim 15, wherein the first screen of the first group placed in the sample holder is used for measuring fluorescence or luminescence.

17. The method of claim 15, wherein the second screen of the first group combined with the first or second screens of the second group is used for measuring fluorescence or luminescence.

18. The method of claim 15, wherein the second screen of the first group combined with the third screens of the second group is used for measuring fluorescence and luminescence.

19. The method of claim 15, wherein the third screen of the first group combined with the third screens of the second group is used for measuring transmission or scattering.

20. The method of claim 15, wherein a transparent layer uniformly fluorescing over the area is used as a reference object for estimating the normalized coefficient, where the fluorescing layer is a film fixed on a plastic, optical glass or quartz carrier.
